(19) United States
(12) Patent Application Publication
(10) Pub. No.: US 2016/0034888 A1
(43) Pub. Date: Feb. 4, 2016

(54) PAYMENT CARD VIRTUALIZATION

(71) Applicants: Stephen Capps, San Carlos, CA (US); Daniel J. Shader, Palo Alto, CA (US); Kurt T. Thams, Santa Cruz, CA (US)

(72) Inventors: Stephen Capps, San Carlos, CA (US); Daniel J. Shader, Palo Alto, CA (US); Kurt T. Thams, Santa Cruz, CA (US)

(73) Assignee: PayNearMe, Inc., Sunnyvale, CA (US)

(21) Appl. No.: 14/450,043

(22) Filed: Aug. 1, 2014

(51) Int. Cl. G06Q 20/34

(52) U.S. Cl. CPC G06Q 20/351

(57) ABSTRACT

Disclosed herein are methods and systems for facilitating payment from a branded stored-value account. In the disclosed systems and methods, a communications interface of a service provider system receives a confirmation that a stored-value account, branded for a first merchant, contains a value. The communications interface also receives a request to enable a payment using the value from the first-merchant-branded stored-value account at a second merchant. Then the communications interface transmits a request to the first-merchant-branded stored-value account for an amount from the first-merchant-branded stored-value account and receives the requested amount from the first-merchant-branded stored-value account. The communications interface and a processor of the service provider system then place the amount in a virtual account, and the communications interface initiates a display showing the amount in the virtual account as a branded stored-value account for the second merchant.

### SUMMARY

Disclosed herein are methods and systems for facilitating payment from a branded stored-value account. In the disclosed systems and methods, a communications interface of a service provider system receives a confirmation that a stored-value account, branded for a first merchant, contains a value. The communications interface also receives a request to enable a payment using the value from the first-merchant-branded stored-value account at a second merchant. Then the communications interface transmits a request to the first-merchant-branded stored-value account for an amount from the first-merchant-branded stored-value account and receives the requested amount from the first-merchant-branded stored-value account. The communications interface and a processor of the service provider system then place the amount in a virtual account, and the communications interface initiates a display showing the amount in the virtual account as a branded stored-value account for the second merchant.

### BRIEF DESCRIPTION OF THE FIGURES

Together with this written description, the figures further explain the principles of, and to enable a person skilled in the relevant art, to make and use the claimed systems and methods.

FIG. 1 is a flow diagram illustrating one embodiment of relationships between parties involved in the presented systems and methods.

FIG. 2 illustrates one embodiment of a stored-value card.

FIG. 3 is a schematic drawing of an exemplary service provider system used to implement the methods presented herein.

FIG. 4 is a high-level process chart illustrating one embodiment of operation.

FIG. 5 is a high-level process chart illustrating another embodiment of operation.

### DETAILED DESCRIPTION

Stored-value accounts have risen in popularity as an alternative to cash or other forms of payment. A stored-value account refers to monetary or other value (such as points, miles, Stars (Starbucks rewards), and alternative currencies such as Bitcoin) stored in a merchant account for use at that specific merchant. Stored-value accounts may be loaded one time or can be rechargeable. One-time load accounts have a one-time limit, for example merchant gift cards and prepaid phone cards.

Rechargeable accounts, on the other hand, can be reloaded and used again like a credit card. But unlike a credit card, the user cannot go into debt with a stored-value account because the user can only use the amount in the account. One popular example of a stored-value account is the Starbucks Card that allows users to add money to their account, earn birthday and other rewards, and receive exclusive offers, all for use at Starbucks and affiliated merchants. Stored value-accounts, including stored-value cards, can save customers and/or merchants considerable amounts of money by allowing lower transaction fees for the customers and/or merchants for each use of the stored-value account.

Two additional categories of stored-value accounts are closed-system accounts and semi-closed-system accounts. In closed-system accounts, payments from the account are only accepted at a single merchant. For example, a customer may buy a card for a fixed amount and can only use the card at the merchant that issued the card. Merchants often prefer these types of accounts because they ensure the stored funds are spent only at their stores. Generally, few if any laws govern these types of accounts, and closed-system account issuers are not normally required to obtain a money transmitter license.

Semi-closed system accounts are similar to closed-system accounts. However, holders of semi-closed system accounts are permitted to make payments using their accounts at multiple merchants, for example, those within a geographic area. These types of accounts are generally issued by a third party, rather than the merchant who accepts the card. Examples include university card accounts and mall gift card accounts. The laws governing these types of cards are unsettled. Depending on the state, the issuer may or may not be required to have a money transmitter license or other similar license. For example, the District of Columbia, Connecticut, Florida, Illinois, Iowa, Louisiana, Maryland, Minnesota, Mississippi, North Carolina, Oregon, Texas, Vermont, Virginia, West Virginia, Washington, and Wyoming all explicitly require a money transmitter license to operate a semi-closed stored-value system. And other states may require a license depending on the interpretation of their laws. Moreover, under federal law, it is a crime for an issuer to conduct a money transmitting business without a license.

In addition to the possible legal pitfalls with semi-closed systems and the need for a money transmitter license, semi-closed systems suffer from problems with customer perception of who is responsible for a given transaction. For example, if a customer purchases a stored-value account at a first merchant and uses the account at a second merchant within a semi-closed system, the customer may not know who is responsible for problems with the transaction: the first merchant, the second merchant, or the third-party issuer. Because customer service is very expensive, the first merchant may not want to provide customer service for a transaction made at the second merchant without some prior agreement between the merchants and an agreed-upon method for accounting and reporting the costs of the customer service to the second merchant or the third-party issuer.

According to one embodiment, systems and methods for facilitating payment from a branded stored-value account that overcome many of the difficulties of the current systems. Un a further embodiment, the systems and methods do not require merchants to obtain money transmitter licenses and that overcome the problems of customer-identification of the responsible merchant.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

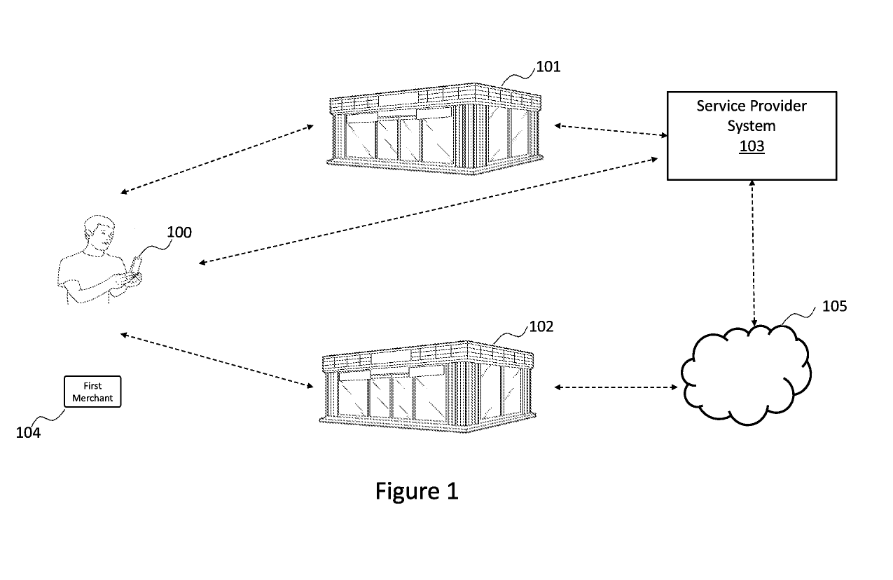

FIG. 1 is a high-level flow illustration, showing exemplary relationships between the parties involved in the presented systems and methods. In this example, four parties are involved: (1) a customer 100; (2) a first merchant 101; (3) a second merchant 102; and (4) a service provider having a service provider system 103. The dashed lines in FIG. 1 generally represent a flow of information, data, or interaction between the respective parties. In practice, the dashed lines in FIG. 1 may represent user interfaces and/or application program interfaces (APIs) for the transmission of information, data, instructions, funds, etc. The flow of information, data, or process between the respective parties may be direct or may flow through systems or parties not shown in FIG. 1.

In a scenario consistent with FIG. 1, a customer 100 opens or receives a stored-value account 104 with the first merchant 101. The stored-value account 104 is represented as a card in FIG. 1. The account 104 is branded because it displays information for the first merchant 101 indicating to the customer 100 that the stored-value account may be used at the first merchant 101. In one embodiment, the first merchant 101 is responsible for maintaining the stored-value account 104. Alternatively, a service provider or a third party may be responsible for maintaining the stored-value account 104. The branded stored-value account 104 may be accessed by the user with a stored-value card (as shown in FIG. 1) or the stored-value account 104 may be accessible through a computer or a mobile device. The stored-value account 104 can be a closed-system or semi-closed system. In a further embodiment, features may be applicable in an open system. After the customer opens or receives the stored-value account 104, the customer may want to spend the value of the stored-value account 104 at a second merchant 102. But if the stored-value account is a closed-system account, a semi-closed-system account to which the second merchant 102 is not a member, or has closed-system aspects preventing use of value in the stored-value account 104 at the second merchant 102, the customer 100 cannot use the value of the stored-value account 104 at the second merchant 102.

According to one embodiment, the service provider system 103 receives a request to enable a payment using the value in the stored-value account 104 for the first merchant 101 at the second merchant 102. The request can come from various sources including the customer 100, the first merchant 101, or the second merchant 102. Alternatively, the request may be generated automatically including through geolocation information for the customer. For example, geolocation information may be used to determine that the customer 100 has entered a physical location of the second merchant 102 and the request to enable a payment could be sent automatically to the service provider 103 or generated by a portion of the service provider system 103 according to the geolocation information.

The service provider system 103 also receives a confirmation that the stored-value account 104 contains a value. Alternatively, the service provider system 103 receives a confirmation by determining from its own records that the stored-value account 104 contains a value. The service provider system 103 then transmits a request to the entity responsible for holding or maintaining the first-merchant-branded stored-value account 104 for an amount from the stored-value account 104 for the customer 100 to use at the second merchant 102. The service provider system 103 receives the requested amount from the entity responsible for holding or maintaining the first-merchant-branded stored-value account 104 and places the amount in a virtual account 105. Then the service provider system 103 initiates a display showing the amount in the virtual account as a branded stored-value account for the second merchant 102. This display can be a display on computer screen or mobile device for the customer 100 or it may be a printed sheet or card indicating that the second-merchant 102 is responsible for the second-merchant-branded stored-value account. The display showing the amount in the virtual account as a branded stored-value account for the second merchant may also show contact information for the second merchant. Contact information can be a phone number, email address, website link, click-to-chat, click-to-dial, or the like. The display indicating that the second-merchant 102 is responsible for the new stored-value account is important so that the customer 100 knows to contact the second merchant 102 regarding any issues with the virtual stored-value account including returns, balance inquiries, or issues requiring customer service. Also, in this embodiment, because the service provider handles the transmission of any money instead of the first merchant 101 or the second merchant 102, the merchants are not required to obtain money transmitter licenses.

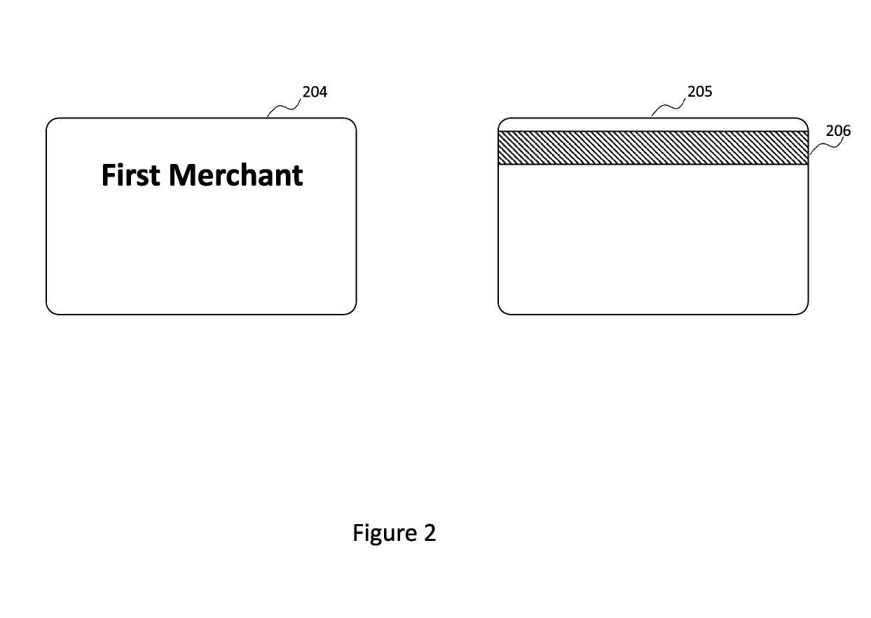

FIG. 2 shows one embodiment of a stored-value card that may be used. The front side of the stored-value card 204 may include the name and/or logo of the issuing or responsible merchant. In the example in FIG. 204, the first merchant 101 is the issuing or responsible merchant responsible for maintaining the first-merchant-branded stored-value account 104. Alternatively, a service provider or a third party may be responsible for maintaining the stored-value account 104.

FIG. 2 also illustrates the back side of the stored-value card 205. In FIG. 2, the back side of the card 205 includes a magnetic stripe 206 for conveying account information including account numbers and the value associated with the account. The value associated with a stored-value account can be accessed using a variety of methods including using a magnetic stripe embedded in a card, a card number, radio-frequency identification (RFID), or barcode. The account identification may also be delivered on a variety of media including a plastic or paper card, a paper slip, a mobile device screen, or manually keyed in.

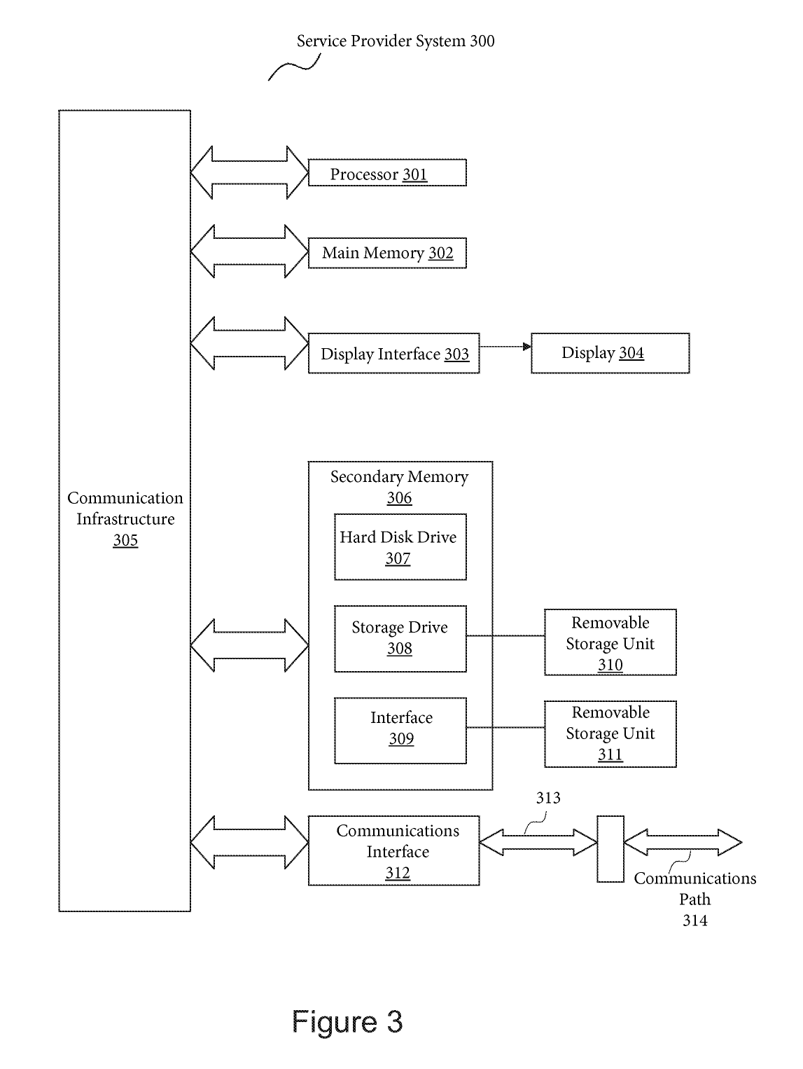

The service provider system 103 may comprise one or more computer systems capable of carrying out the functionality described herein. For example, FIG. 3 is a schematic drawing of a service provider system 300 used to implement the methods presented herein. Service provider system 300 includes one or more processors, such as processor 301. The processor 301 is connected to a communication infrastructure 305 (e.g., a communications bus or network). Computer system 300 can include a display interface 303 that forwards graphics, text, and other data from the communication infrastructure 305 (or from a frame buffer not shown) for display on a local or remote display unit 304.

Service provider system 300 also includes a main memory 302, such as random access memory (RAM), and may also include a secondary memory 306. The secondary memory 306 may include, for example, a hard disk drive 307 and/or a removable storage drive 308, representing a floppy disk drive, a magnetic tape drive, an optical disk drive, flash memory device, etc. The removable storage drive 308 reads from and/or writes to a removable storage unit 310. Removable storage unit 310 represents a flash memory device including a USB drive, etc., which is read by and written to by removable storage drive 308. The removable storage unit 310 includes a computer usable storage medium having stored therein computer software, instructions, and/or data.

In alternative embodiments, secondary memory 306 may include other similar devices for allowing computer programs or other instructions to be loaded into a service provider system 300. Such devices may include, for example, a removable storage unit 311 and an interface 309. Examples of such may include a removable memory chip (such as an erasable programmable read only memory (EPROM), or programmable read only memory (PROM)) and associated socket, and other removable storage units 311 and interfaces 309, which allow computer software, instructions, and/or data to be transferred from the removable storage unit 311 to a service provider system 300.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Service provider system 300 may also include a communications interface 312. Communications interface 312 allows computer software, instructions, and/or data to be transferred between a service provider system 300 and external devices. Examples of communications interface 312 may include a wired or wireless network interface, a communications port, etc. Software and data transferred via communications interface 312 are in the form of signals 313 which may be electronic, electromagnetic, optical, or other signals capable of being transmitted or received by communications interface 312. These signals 313 are provided to and from the communications interface 312 via a communications path (e.g., channel) 314. This channel 314 carries signals 313 and may be implemented using wire or cable, fiber optics, a telephone line, a cellular link, a radio frequency (RF) link, a wireless communication link, and other communications channels.

Computer programs (also referred to as computer control logic) are stored in main memory 302 and/or secondary memory 306. Computer programs may also be received via communications interface 312. Such computer programs, when executed, enable the service provider system 300 to perform features discussed herein. In particular, the computer programs, when executed, enable the processor 301 to perform the features of the presented methods. Accordingly, such computer programs represent controllers of the service provider system 300.

In an embodiment, software may be stored in a computer program product and loaded into a service provider system 300 using removable storage drive 308, interface 309, hard drive 307, or communications interface 312. The control logic (software), when executed by the processor 301, causes the processor 301 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

In one embodiment, the communications interface of a service provider system 103 receives a confirmation that a stored-value account 104 branded for a first merchant 101 contains a value. The communications interface of the service provider also receives a request to enable a payment using the value from the first-merchant-branded stored-value account at a second merchant 102. The communications interface of the service provider system 103 then transmits a request to the entity responsible for maintaining the stored-value account 104 for an amount from the first-merchant-branded stored-value account 104 and receives the requested amount from the first-merchant-branded stored-value account. The communications interface and a processor of the service provider system 103 place the amount in a virtual account 105. And the communications interface of the service provider system initiates a display showing the amount in the virtual account as a branded stored-value account for the second merchant.

In one embodiment, the virtual account is an account held by the second merchant. Alternatively, the virtual account is held by the first merchant or the service provider.

In another embodiment, the communications interface of the service provider system transfers the amount from the virtual account to the second merchant as a payment. After the payment is made, the customer may wish to return the purchased item and reverse the payment. Because the customer received a display showing the amount in the virtual account as branded for the second merchant, the customer will work through the second merchant to reverse the payment. In one example, when the customer requests a reversal of the payment, the second merchant sends a request to the service provider system to reverse the payment. The communications interface of the service provider system receives the request from the second merchant to reverse the payment and reverses the payment.

When a payment is reversed, the merchants or the service provider may wish to restrict how the reversed payment may be used in the future. For example, the second merchant may have a policy that returns may only be exchanged for store credit. In one example, the processor of the service provider system may mark the reversed payment as restricted, that is, the reversed payment may not put funds back into general use. Restrictions may include that the customer's component the reversed balance that is restricted can only be spent at a specific merchant, or must be spent within a certain time (e.g., must be spent within 30 days). Also, reversals may have reversal of fees associated with the initial amount spent.

As discussed above, the value in the stored-value account may be money including standard and alternative currencies like Bitcoin, miles, points, Stars, or other types of rewards. The processor of the service provider system may have to convert the amount from the first-merchant-branded stored-value account from a first value type to a second value type. For example, if the first-merchant-branded stored-value account contains rewards points, but the second merchant only deals in dollars, the service provider system may convert the miles to dollars using exchange criteria and rates determined by the merchants, the service provider, or general exchange rates. The exchange criteria and rates may include, for example, a limitation on the amount from the first-merchant-branded stored-value account that may be used at the second merchant or the frequency at which value form the first-merchant-branded stored-value account may be used at the second merchant.

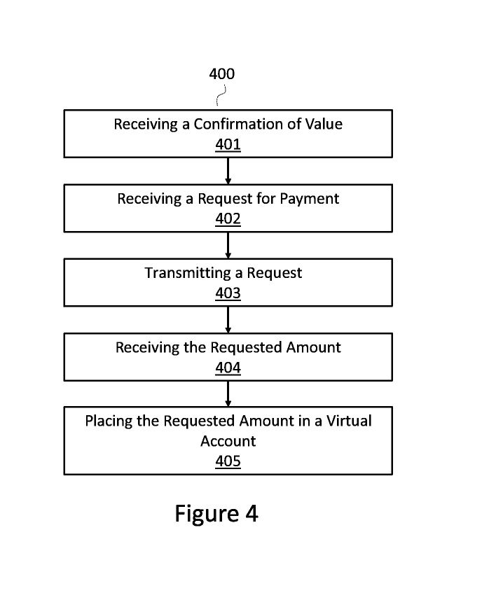

FIG. 4 is a high-level flowchart illustrating a method 400 for the service provider system to facilitate payment from a branded stored-value account as described above. The method includes: 401 receiving a confirmation that a stored-value account branded for a first merchant contains a value; 402 receiving a request to enable a payment using the value from the first-merchant-branded stored-value account at a second merchant; 403 transmitting a request to the entity responsible for maintaining the stored-value account for an amount from the first-merchant-branded stored-value account; 404 receiving the requested amount from the first-merchant-branded stored-value account; 405 placing the amount in a virtual account; and 406 initiating a display showing the amount in the virtual account as a branded stored-value account for the second merchant.

In another embodiment, the systems and methods may be used with a mobile device of a customer. The mobile device may contain the elements shown in FIG. 3 and described in connection with FIG. 3 above. In one example, the mobile device comprises memory, a communications interface, a processor, and a display. The mobile device stores in its memory a confirmation that a stored-value account branded for a first merchant contains a value. The customer may view the amount on the display of the mobile device. Because the account is branded, the screen showing the value may include the name, logo, and/or a page design determined by the first merchant.

The communications interface of the mobile device receives a request to enable a payment using the value from the first-merchant-branded stored-value account at a second merchant. This request may be from the customer selecting or inputting the second merchant is an application of the mobile device. Alternatively, the request can be automatically generated through geolocation information for the mobile device or may be initiated by the second merchant. The communications interface of the mobile device transmits a request to the entity responsible for maintaining the stored-value account for an amount from the first-merchant-branded stored-value account. This request may go directly to the entity responsible for maintaining the stored-value account, or it may go to the service provider who then transmits the request to the entity responsible for maintaining the stored-value account. Then the communications interface of the mobile device receives a confirmation that the requested amount from the first-merchant-branded stored-value account has been placed in a virtual account. This confirmation may come directly from the entity responsible for maintaining the stored-value account or it may come through the service provider. After receiving the confirmation, the display of the mobile device displays the amount in the virtual account as a branded stored-value account for the second merchant.

The communications interface of the mobile device may also receive confirmation that the amount from the virtual account was transferred to the second merchant as the payment. Also, if the customer wants to reverse the payment, the communications interface of the mobile device may receive a request to reverse the payment. This request may come from direct customer input to the mobile device, or the request may come from the second merchant directly or via the service provider. After receiving a request to reverse the payment, the communications interface of the mobile device may receive a confirmation of the reversed payment. Reversal may require approval by the second merchant and/or by the customer and/or by the service provider. Reversal may result in creating a restricted-funds balance as described above.

In one embodiment, the mobile device display shows the amount in the first merchant-branded stored-value account with a first skin for the first merchant and shows the amount in the virtual account with a second skin for the second merchant. A skin is a custom graphical appearance achieved by the use of a graphical user interface that can be applied to specific applications. As such a skin can completely change look and feel and navigation interface of an application. The change from the first skin for the first merchant to the second skin for the second merchant helps identify the responsible merchant to the customer.

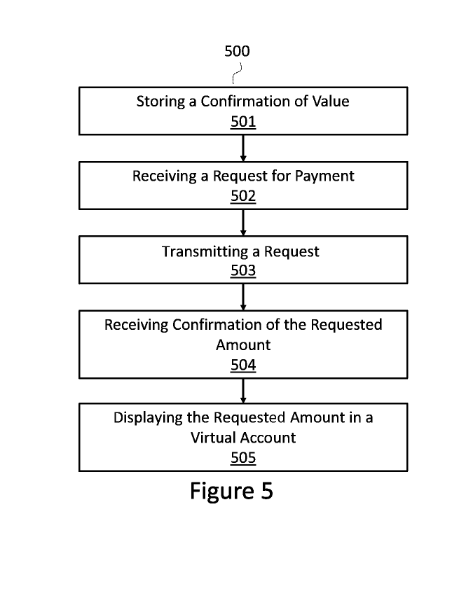

FIG. 5 is a high-level flowchart illustrating a method 500 for facilitating payment from a branded stored-value account with a mobile device. The method includes the mobile device: 501 storing a confirmation that a stored-value account branded for a first merchant contains a value; 502 receiving a request to enable a payment using the value from the first-merchant-branded stored-value account at a second merchant; 503 transmitting a request to the entity responsible for maintaining the stored-value account for an amount from the first-merchant-branded stored-value account; 504 receiving a confirmation that the requested amount from the first-merchant-branded stored-value account has been placed in a virtual account; and 505 displaying the amount in the virtual account as a branded stored-value account for the second merchant.

The figures included herein serve as embodiments of the presented systems and methods. Each individual process or sub-process performed within the embodiments described can be performed by one or more parties, as well as one or more computer systems. For example, in one embodiment, some or all of the communications and data transfers between the customer, service provider system, and merchant are performed via an automated computer-based system, such as an application program interface. As such, the embodiments presented in the figures are not intended to be limiting.

What is claimed is:

1. A computer generated method for facilitating payment from a branded stored-value account comprising the steps of:
receiving, with a communications interface of a service provider system, a confirmation that a stored-value account, branded for a first merchant, contains a value;
receiving, with the communications interface of the service provider system, a request to enable a payment using the value from the first-merchant-branded stored-value account at a second merchant;
transmitting, with the communications interface of the service provider system, a request to the first-merchant-branded stored-value account for an amount from the first-merchant-branded stored-value account;
receiving, with the communications interface of the service provider system, the requested amount from the first-merchant-branded stored-value account;
placing, with the communications interface and a processor of the service provider system, the amount in a virtual account; and
initiating, with the communications interface of the service provider system, a display showing the amount in the virtual account as a branded stored-value account for the second merchant.

2. The method of claim 1 wherein the virtual account is an account held by the second merchant.

3. The method of claim 1 wherein the virtual account is an account held by the service provider.

4. The method of claim 1 further comprising transferring, with the communications interface of the service provider system, the amount from the virtual account to the second merchant as the payment.

5. The method of claim 4 further comprising receiving, with the communications interface of the service provider system, a request from the second merchant to reverse the payment.

6. The method of claim 5 further comprising marking, with the processor of the service provider system, the reversed payment as restricted.

7. The method of claim 1 wherein the value represents a currency.

8. The method of claim 1 wherein the value represents points.

9. The method of claim 1 further comprising converting, with the processor of the service provider system, the amount from the first-merchant-branded stored-value account from a first value type to a second value type.

10. The method of claim 1 wherein the request to make the payment using the value from the first-merchant-branded stored-value account at the second merchant is an automatic request based on geolocation information.

11. The method of claim 1 wherein the display showing the amount in the virtual account as a branded stored-value account for the second merchant also shows contact information for the second merchant.

12. A computer generated method for facilitating payment from a branded stored-value account with a mobile device comprising the steps of:
storing, in a memory of the mobile device, a confirmation that a stored-value account branded for a first merchant contains a value;
receiving, with a communications interface of the mobile device, a request to enable a payment using the value from the first-merchant-branded stored-value account at a second merchant;
transmitting, with the communications interface of the mobile device, a request to the first-merchant-branded stored-value account for an amount from the first-merchant-branded stored-value account;
receiving, with the communications interface of the mobile device, a confirmation that the requested amount from the first-merchant-branded stored-value account has been placed in a virtual account; and
displaying, on the display of the mobile device, the amount in the virtual account as a branded stored-value account for the second merchant.

13. The method of claim 12 wherein the request to enable a payment is initiated by the second merchant.

14. The method of claim 12 wherein the virtual account is an account held by the second merchant.

15. The method of claim 12 further comprising receiving, with the communications interface of the mobile device, confirmation that the amount from the virtual account was transferred to the second merchant as the payment.

16. The method of claim 15 further comprising receiving, with the communications interface of the mobile device, a request to reverse the payment.

17. The method of claim 16 further comprising receiving, with the communications interface of the mobile device, a confirmation of the reversed payment.

18. The method of claim 12 wherein the value represents a currency.

19. The method of claim 12 wherein the value represents points.

20. The method of claim 12 further comprising converting, with a processor of the mobile device, the amount from the first-merchant-branded stored-value account from a first value type to a second value type.

21. The method of claim 12 wherein the request to make the payment using the value from the first-merchant-branded stored-value account at the second merchant is an automatic request based on geolocation information.

22. The method of claim 12 wherein the step of displaying the amount in the virtual account further comprises displaying contact information for the second merchant.

23. The method of claim 12 further comprising displaying, on the display of the mobile device, the amount in the first merchant-branded stored-value account with a first skin for the first merchant wherein the step of displaying, on the display of the mobile device, the amount in the virtual account as the branded stored-value account for the second merchant comprises displaying a second skin for the second merchant.
